(19) United States
(12) Patent Application Publication
(10) Pub. No.: US 2014/0308499 A1
(43) Pub. Date: Oct. 16, 2014

(54) WINDOW FOR DISPLAY DEVICE AND DISPLAY DEVICE INCLUDING THE WINDOW PANEL

(71) Applicant: SAMSUNG DISPLAY CO., LTD., Yongin-City (KR)

(72) Inventors: Sang-Gu KIM, Yongin-City (KR); Jee-Seok OH, Yongin-City (KR); Ju-Suk OH, Yongin-City (KR); Hun-Kyo KIM, Yongin-City (KR)

(73) Assignee: SAMSUNG DISPLAY CO., LTD., Yongin-City (KR)

(21) Appl. No.: 14/231,776

(22) Filed: Apr. 1, 2014

(30) Foreign Application Priority Data
Apr. 15, 2013 (KR) 10-2013-0041253

(51) Int. Cl. B32B 27/08; B32B 27/32; B32B 27/40; B32B 27/36

(52) U.S. Cl. CPC B32B 27/08; B32B 27/365; B32B 27/325; B32B 27/36; B32B 27/40; B32B 2255/26; B32B 2255/20; B32B 2307/412
USPC 428/220; 428/412; 428/523; 428/480; 428/423.3; 428/337; 428/338; 428/335

(57) ABSTRACT

A window for a display device includes a polymer resin layer including a polymer resin, and a light transmittance film positioned on at least one side of the polymer resin layer and including an adhesive film, the adhesive film including a same polymer resin as the polymer resin layer.

### CROSS-REFERENCE TO RELATED APPLICATION

Korean Patent Application No. 10-2013-0041253, filed on Apr. 15, 2013, in the Korean Intellectual Property Office, and entitled: “Window For Display Device and Display Device Including the Window Panel,” is incorporated by reference herein in its entirety.

### BACKGROUND

1. Field

A window for a display device and a display device including the same are disclosed.

2. Description of the Related Art

Currently known display devices include a liquid crystal display (LCD), a plasma display panel (PDP), an organic light emitting diode display (OLED), a field effect display (FED), an electrophoretic display device, and the like. Such a display device includes a display module displaying image and a window protecting the display module.

### SUMMARY

Embodiments are directed to a window for a display device including a polymer resin layer including a polymer resin, and a light transmittance film positioned on at least one side of the polymer resin layer, the light transmittance film including an adhesive film, the adhesive film including a same polymer resin as the polymer resin layer.

The polymer resin layer may contact the adhesive film.

The polymer resin may include polycarbonate (PC), polymethylmethacrylate (PMMA), polyethylene terephthalate (PET), urethane, a cycloolefin polymer (COP), a copolymer thereof, or a combination thereof.

The polymer resin layer may have a thickness of about 300 to about 800 μm.

The light transmittance film may further include a hard coating layer positioned on one side of the adhesive film.

The hard coating layer may have a thickness of about 100 to about 250 μm.

The hard coating layer may include an organic material, an inorganic material, or an organic/inorganic composite compound.

The adhesive film has a thickness of about 30 to about 70 μm.

The adhesive film has a thickness of about 40 to about 60 μm.

The light transmittance film may include an IMD (in mold decoration) film.

The IMD film may not include a binder layer.

The window may have a thickness of less than or equal to about 1 mm.

The window may be obtained by injection molding the light transmittance film and the polymer resin in a film insert manner.

A display device may include the window.

### BRIEF DESCRIPTION OF THE DRAWING

Features will become apparent to those of ordinary skill in the art by describing in detail exemplary embodiments with reference to the attached drawings in which:

FIG. 1 illustrates a cross-sectional view showing a window for a display device according to one embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

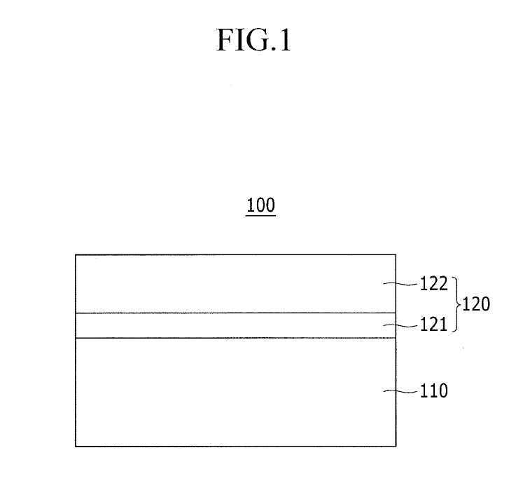

Referring to FIG. 1, a window for a display device according to an embodiment will be described. FIG. 1 illustrates a cross-sectional view of a window for a display device according to an embodiment.

A window 100 for a display device according to one embodiment includes a polymer resin layer 110 and a light transmittance film 120 positioned on at least one side of the polymer resin layer 110, the light transmittance film 120 including an adhesive film 121. The adhesive film includes a polymer resin. The polymer resin layer 110 includes the same polymer resin as the adhesive film 121.

The polymer resin layer 110 may be made of an injection moldable polymer resin. The injection moldable polymer resin may include, for example polycarbonate (PC), polymethylmethacrylate (PMMA), polyethylene terephthalate (PET), urethane, a cycloolefin polymer (COP), a copolymer thereof, or a combination thereof. Herein, the ‘combination’ may refer to a blend or a stack of two or more layers.

The polymer resin layer 110 may have a thickness of, for example, about 300 to about 800 μm, or, for example, about 500 to about 700 μm.

When the polymer resin layer 110 has a thickness within this range, a sufficient space for inflow of the polymer resin in a film insert manner during the injection molding may be secured, and a satisfactory appearance of a window, as well as satisfactory impact resistance and surface hardness characteristics of the polymer resin, may be obtained.

The light transmittance film 120 may further include a hard coating layer 122 positioned on one side of the adhesive film 121. The light transmittance film 120 may be positioned on an opposite side of the adhesive film 121 from the polymer resin layer 110.

The adhesive film 121 may be a plastic substrate used for a film insert forming process, and may contact the polymer resin layer 110 directly. A binder layer may be omitted between the polymer resin layer 110 and the adhesive film 121.

The adhesive film 121 may include the same material as the polymer resin of the polymer resin layer 110. For example, when the polymer resin layer 110 includes polycarbonate (PC), the adhesive film 121 may also include polycarbonate (PC). When the polymer resin layer 110 includes polyethylene terephthalate (PET), the adhesive film 121 may also include polyethylene terephthalate (PET), etc.

In this way, when the adhesive film 121 and the polymer resin layer 110 include the same material, adherence between the adhesive film 121 and the polymer resin layer 110 may be improved without using a separate binder therebetween. In addition, the absence of a separate binder between the adhesive film 121 and the polymer resin layer 110 may prevent reliability deterioration by the binder. Such reliability deterioration by a binder may include, for example, interface separation due to physicochemical characteristic differences between the binder and a polymer resin as well as increase of a yellow index and decrease of adherence due to phase separation and deterioration of the binder at an injection temperature of the polymer, for example, in a film insert forming process during manufacture of a window. According to the embodiment, the adhesive film 121 and the polymer resin layer 110 are formed of the same polymer. Accordingly, adherence therebetween may not only be secured but reliability deterioration by the binder may also be or reduced.

The adhesive film 121 may have a thickness of, for example, about 30 μm to about 70 μm, or, for example, about 40 μm to about 60 μm.

The hard coating layer 122 may be positioned on a surface of the window 100 for a display device and thus may improve surface hardness. The hard coating layer 122 may include, for example an organic material, an inorganic material, or an organic/inorganic composite compound. The organic material may include, for example, an acryl-based compound, an epoxy-based compound, or a combination thereof. The inorganic material may include, for example silica, alumina, or a combination thereof. The organic/inorganic composite compound may include, for example, polysilsesquioxane. The hard coating layer 122 may be a monolayer or a plural layer, and may have a thickness of, for example, about 100 μm to about 250 μm and specifically about 125 μm to about 200 μm.

The polymer resin layer 110 and hard coating layer 122 may include at least one layer.

The light transmittance film 120 may include, for example an IMD film (in mold decoration film). The IMD film may not include a binder layer.

According to the embodiment, the light transmittance film 120 is formed on one side of the polymer resin layer 110. In other implementations, the light transmittance film 120 may be formed on both sides of the polymer resin layer 110.

The window 100 for a display device may be obtained by injection-molding the light transmittance film 120 and the aforementioned polymer resin in a film insert manner.

The window 100 for a display device may have a thickness of less than or equal to about 1 mm.

A conventional window for a display device uses a binder to adhere a polymer resin layer to a hard coating layer. In such a window, since the binder includes materials that are different from a polymer resin, the binder adheres the polymer resin layer to the hard coating layer by a heterojunction method. Accordingly, water may be generated on the interface between the binder including different materials from the polymer resin and the polymer resin layer and thus, an interface separation and film delamination may occur. The binder may not be mixed at an injection temperature. Accordingly, reliability may deteriorate and yellowing, and the like, of a window may occur.

According to an exemplary embodiment, a window 100 for a display device includes an adhesive film formed of the same material as a polymer resin layer as described above. The window 100 for a display device may use the same polymer resin as an adhesive film instead of using a binder and thus, may provide a homojunction instead of the heterojunction. Accordingly, adherence between the polymer resin layer and the adhesive film or between the polymer resin layer and a light transmittance film may be improved, and separation on the interface thereof may be prevented. Thus, film delamination and yellowing by the binder may be prevented.

The above described window for a display device may be applied in various display devices. For example, the display device may be a liquid crystal display (LCD), an organic light emitting diode (OLED) display, a plasma display, an electric field effect display device, an electrophoresis display device, or the like.

The window for a display device may be disposed on a display module, which may be a liquid crystal display module, an organic light emitting display module, a plasma display module, an electric field effect display module, an electrophoresis display module, or the like.

The following Examples and Comparative Examples are provided in order to highlight characteristics of one or more embodiments, but it is to be understood that the Examples and Comparative Examples are not to be construed as limiting the scope of the embodiments, nor are the Comparative Examples to be construed as being outside the scope of the embodiments. Further, it is to be understood that the embodiments are not limited to the particular details described in the Examples and Comparative Examples.

Manufacture of Window for Display Device

### EXAMPLE 1

A polysilsesquioxane solution was coated on one side of a PC film (PC2151, Teijin Chemicals Ltd.), dried at 80° C. for 1 minute, and cured by ultraviolet (UV) radiation (300 mJ/cm²). The PC film was put in an injection molder to injection-mold polycarbonate (PC) (HFD1810, SABIC Co.), manufacturing a 0.8 mm-thick window for a display device including a 600 μm-thick polycarbonate (PC) resin layer, a 50 μm-thick PC film, and a 150 μm-thick hard coating layer.

### EXAMPLE 2

A 0.8 mm-thick window for a display device including a 600 μm-thick polyethylene terephthalate (PET) resin layer, a 50 μm-thick PET film, and a 150 μm-thick hard coating layer was manufactured according to the same method as Example 1 except for using polyethylene terephthalate (PET) (A4300, Toyobo Co., Ltd.) instead of polycarbonate (PC).

### EXAMPLE 3

A 0.8 mm-thick window for a display device including a 600 μm-thick urethane resin layer, a 50 μm-thick urethane film, and a 150 μm-thick hard coating layer was manufactured according to the same method as Example 1 except for using urethane (Urethane) (Keiwa Inc.) instead of polycarbonate (PC).

### EXAMPLE 4

A 0.8 mm-thick window for a display device including a 600 μm-thick cycloolefin polymer (COP) resin layer, a 50 μm-thick COP film, and a 150 μm-thick hard coating layer was manufactured according to the same method as Example 1 /except for using a cycloolefin polymer (COP) (Zeon Co.) instead of the polycarbonate (PC).

### COMPARATIVE EXAMPLE 1

A polysilsesquioxane solution was coated on one side of a PC film (PC2151, Teijin Chemicals Ltd.), dried at 80° C. for 1 minute, and cured by ultraviolet (UV) radiation (300 mJ/cm2). Subsequently, an acrylic binder solution was coated on the other side of the PC film and dried at 100° C. for 10 minutes. Then, the resulting PC film was pre-cured at 100° C. Then, the PC film was put in an injection molder to injection-mold polycarbonate (PC) (HFD1810, SABIC Co.), obtaining a 1 mm-thick window for a display device including a 600 μm-thick polycarbonate (PC) resin layer.

### COMPARATIVE EXAMPLE 2

A 1 mm-thick window for a display device including a 600 μm-thick polycarbonate-polymethylmethacrylate (PC-PMMA) copolymer resin layer was manufactured according to the same method as Comparative Example 1 except for using a polycarbonate-polymethylmethacrylate (PC-PMMA) copolymer (C001, Sumitomo Co.) instead of polycarbonate (PC).

### COMPARATIVE EXAMPLE 3

A 1 mm-thick window for a display device including a 600 μm-thick cycloolefin polymer (COP) resin layer was manufactured according to the same method as Comparative Example 1 except for using a cycloolefin polymer (COP) (Zeon Co.) instead of the polycarbonate (PC).

Evaluation

Yellowing degrees, environmental reliability (adherence), and appearance of the windows for a display device according to Examples 1 to 4 and Comparative Examples 1 to 3 were evaluated.

The yellowing degree was measured with a reference to a YI (yellow index, D1925). Initial transmittance (an initial YI value) was measured using a CM 3600D spectrophotometer. The distance between the sample and a UV B Lamp (a wavelength ranging from 280-360 nm) was 20 cm. Post transmittance (post YI value) was measured after each sample was allowed to stand for 72 hours.

The environmental reliability (adherence) was evaluated by exposing the windows for a display device to a condition of 93% humidity at a temperature of 60° C. for a period of 120 hours, or by exposing the windows to a condition of 85% humidity at a temperature of 85° C. for a period of 120 hours.

The appearance was evaluated by the naked eye to see if the windows for a display device were curled or distorted

The results are provided in Table 1.

TABLE 1

| | | Environmental reliability | | |
|---|---|---|---|---|
| | | (adherence) | | |
| | | 60° C./ | 85° C./ | |
| | YI (D1925) | 93%/120 Hr | 85%/120 Hr | Appearance |
| Example 1 | 1.31 | ∘ | ∘ | OK |
| Example 2 | 1.08 | ∘ | ∘ | OK |
| Example 3 | 2.48 | ∘ | ∘ | OK |
| Example 4 | 1.13 | ∘ | ∘ | OK |
| Comparative | 4.68 | Δ | x | OK |
| Example 1 | | | | |
| Comparative | 5.03 | Δ | x | Curled |
| Example 2 | | | | |
| Comparative | — | X | x | Wavy |
| Example 3 | | | | |

Evaluation Reference of Environmental Reliability
◯: no film delamination
Δ: partial film delamination
x: complete film delamination

Referring to Table 1, the windows for a display device according to Examples 1 to 4 exhibited excellent adherence, a low yellow index, and satisfactory environmental reliability and appearance. On the other hand, the window for a display device according to Comparative Example 1 exhibited some yellowing and had unsatisfactory environmental reliability. The window for a display device according to Comparative Example 2 exhibited yellowing and had unsatisfactory and environmental reliability, and insufficient appearance. The window for a display device according to Comparative Example 3 exhibited insufficient adherence, environmental reliability, and appearance.

Based on the results, the windows for a display device according to Examples 1 to 4 exhibited satisfactory adherence, yellow index, environmental reliability, and appearance.

By way of summation and review, glass may be used as a window of a display device. However, glass may be easily broken by external impact. When glass is used for a portable device such as a mobile phone, the window may be easily damaged. Therefore, recently, a window made of plastic material instead of glass has been researched. Generally, a window made of a plastic material may have a stack structure including a polymer resin and a binder. However, the polymer resin and the binder may have physicochemical characteristic differences; and thus, separation or detachment of the layers of the window on the interface may occur. Reliability of the window may deteriorate and undesirable characteristics such as yellowing may occur.

Embodiments provide a window for a display device that may increase adherence between layers and simultaneously, improve reliability. Embodiments further provide a display device including the window. Adherence between a polymer resin layer and a light transmittance film including a window for a display device may be improved and simultaneously, yellowing of the window for a display device may be prevented or reduced, and reliability of the window may be improved.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope thereof as set forth in the following claims.

What is claimed is:

1. A window for a display device, the window comprising
a polymer resin layer including a polymer resin; and
a light transmittance film positioned on at least one side of the polymer resin layer, the light transmittance film including an adhesive film, the adhesive film including a same polymer resin as the polymer resin layer.

2. The window for a display device as claimed in claim 1, wherein the polymer resin layer contacts the adhesive film.

3. The window for a display device as claimed in claim 1, wherein the polymer resin includes polycarbonate (PC), polymethylmethacrylate (PMMA), polyethylene terephthalate (PET), urethane, a cycloolefin polymer (COP), a copolymer thereof, or a combination thereof.

4. The window for a display device as claimed in claim 1, wherein the polymer resin layer has a thickness of about 300 to about 800 μm.

5. The window for a display device as claimed in claim 1, wherein the light transmittance film further includes a hard coating layer positioned on one side of the adhesive film.

6. The window for a display device as claimed in claim 5, wherein the hard coating layer has a thickness of about 100 to about 250 μm.

7. The window for a display device as claimed in claim 5, wherein the hard coating layer includes an organic material, an inorganic material, or an organic/inorganic composite compound.

8. The window for a display device as claimed in claim 1, wherein the adhesive film has a thickness of about 30 to about 70

9. The window for a display device as claimed in claim 1, wherein the adhesive film has a thickness of about 40 to about 60 μm.

10. The window for a display device as claimed in claim 1, wherein the light transmittance film includes an IMD (in mold decoration) film.

11. The window for a display device as claimed in claim 10, wherein the IMD film does not include a binder layer.

12. The window for a display device as claimed in claim 1, wherein the window has a thickness of less than or equal to about 1 mm.

13. The window for a display device as claimed in claim 1, the window being obtained by injection molding the light transmittance film and the polymer resin in a film insert manner.

14. A display device comprising the window for a display device as claimed in claim 1.
